(19) United States
(12) Patent Application Publication
(10) Pub. No.: US 2016/0315722 A1
(43) Pub. Date: Oct. 27, 2016

(54) AUDIO STEM DELIVERY AND CONTROL

(71) Applicant: Apple Inc., Cupertino, CA (US)

(72) Inventor: Tomlinson M. Holman, Cupertino, CA (US)

(21) Appl. No.: 14/693,815

(22) Filed: Apr. 22, 2015

(51) Int. Cl. H04H 60/04; G11B 27/34; G11B 27/031; H04N 5/265; G06F 3/16

(52) U.S. Cl. CPC H04H 60/04; H04N 5/265; G06F 3/16; G11B 27/031; G11B 27/34

(57) ABSTRACT

An audio distribution system is described that includes an audio mixing device and one or more audio playback devices. The audio mixing device may generate final audio mixes for distribution to one or more of the audio playback devices. The final audio mixes may be associated with a video stream (e.g., a movie or television show video stream). The final audio mixes may be composed of separate music and effects and dialogue stems. In some instances, the music and effects and dialogue stems may be separately controlled during playback by the audio playback devices to improve intelligibility of the dialogue stem to users. This separate control may include the adjustment of level or the application of dynamic range compression (DRC) to a combined music and effects stem independent of adjustment of a dialogue stem.

### FIELD

A system and method for controlling a combined music and effects audio stem relative to a dialogue audio stem for a piece of sound program content to increase the intelligibility of the dialogue stem is described.

### BACKGROUND

Sound program content, including movies and television shows, are often composed of several distinct audio components, including dialogue of characters/actors, music, and sound effects. Each of these component parts called stems may include multiple spatial channels and are mixed together prior to delivery to a consumer or a distribution company. For example, a production company may mix a 5.1 channel dialogue stem, a 5.1 music stem, and a 5.1 effects stem into a single master 5.1 audio mix or stream. This master stream/mix may thereafter be delivered to a consumer through a recordable medium (e.g., DVD or Blu-ray) or through an online streaming service.

Although mixing dialogue, music, and effects to form a single master mix or stream is convenient for purposes of distribution, this process often results in poor audio reproduction for the consumer. For example, intelligibility of dialogue may become an issue during playback because the dialogue stem for a piece of sound program content must be played back using the same settings as music and effects stems since each of these components are unified in a single master stream/mix. Dialogue intelligibility has become a growing and widely perceived problem, especially amongst movies played through television sets where dialogue may be easily lost amongst music and effects. Accordingly, an approach is needed that improves intelligibility of dialogue content.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

An audio distribution system is described that includes an audio mixing device and one or more audio playback devices. The audio mixing device may generate final audio mixes for distribution to one or more of the audio playback devices. In some embodiments, the final audio mixes may be associated with a video stream (e.g., a movie or television show video stream). The final audio mixes may be composed of separate music and effects and dialogue stems. In some embodiments, the music and effects and dialogue stems may be separately controlled during playback by the audio playback devices to improve intelligibility of the dialogue stem to users. In one embodiment, this separate control includes the adjustment of level of a combined music and effects stem independent of adjustment of a dialogue stem. This level control may be below a predefined threshold value. For example, attenuation of the combined music and effects stem may be limited to 20 dB to ensure that the music and effects stem is not entirely eliminated during playback.

In some embodiments, dynamic range compression (DRC) may be selectively applied to the music and effects stem. For instance, when the level of the dialogue stem falls below a predefined DRC level, DRC may be applied to the music and effects stem. In some embodiments, the intensity of DRC may be controlled by the detected sound level of the dialogue stem. For example, as the dialogue stem lowers in level, the intensity of the DRC applied to the music and effects stem may increase. In these low level situations, DRC may improve the intelligibility of the dialogue stem by compressing the dynamic range of the music and effects stem while allowing the dialogue stem to remain unchanged.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 shows an audio distribution system, including an audio mixing device and a set of audio playback devices, according to one embodiment.

FIG. 2 shows a component diagram of the audio mixing device according to one embodiment.

FIG. 3 shows a component diagram of an audio playback device according to one embodiment.

FIG. 4 shows a method for mixing, distributing, and playing back a piece of sound program content comprised of multiple audio stems according to one embodiment.

FIG. 5 shows the construction of separate dialogue, music, and effects stems according to one embodiment.

FIG. 6 shows a graphical user interface that may be presented to a user on a monitor of the audio playback device according to one embodiment.

### DETAILED DESCRIPTION

Several embodiments are described with reference to the appended drawings are now explained. While numerous details are set forth, it is understood that some embodiments of the invention may be practiced without these details. In other instances, well-known circuits, structures, and techniques have not been shown in detail so as not to obscure the understanding of this description.

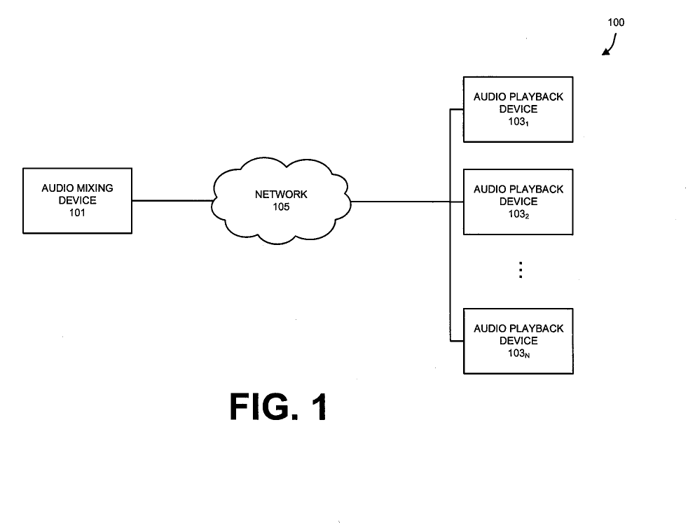

FIG. 1 shows an audio distribution system 100 according to one embodiment. The audio distribution system 100 may include an audio mixing device 101 and one or more audio playback devices 103₁-103_{N}. The audio mixing device 101 may generate final audio mixes for distribution to one or more of the audio playback devices 103₁-103_{N}. In some embodiments, the final audio mixes may be associated with a video stream (e.g., a movie or television show video stream). As shown in FIG. 1, the final audio mixes may be distributed over a network 105; however, in other embodiments the final audio mixes may be distributed to the audio playback devices 103₁-103_{N} using any other medium or technique (e.g., DVD or Blu-ray discs). As will be described in greater detail below, the final audio mixes may be composed of separate music and effects and dialogue stems. The music and effects and dialogue stems may be separately controlled during playback by the audio playback devices 103₁-103_{N} to improve intelligibility of the dialogue stem to users. In one embodiment, this separate control includes the adjustment of a level of a combined music and effects stem independent of adjustment of a dialogue stem. Each element of the audio distribution system 100 will now be described by way of example.

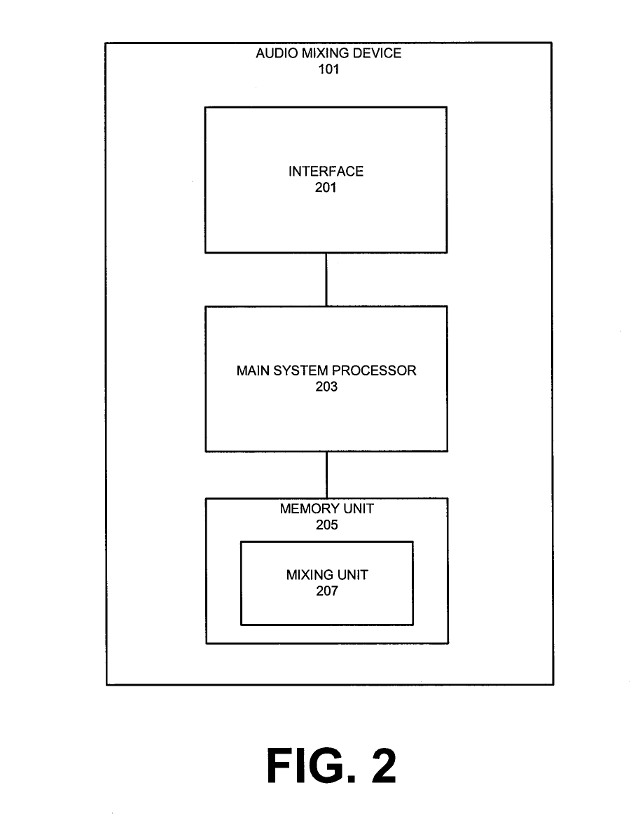

FIG. 2 shows a component diagram of the audio mixing device 101 according to one embodiment. The audio mixing device 101 may be any computing device that is capable of combining and mixing audio elements as will be described in greater detail below. For example, the audio mixing device 101 may be a computer server, a desktop computer, a laptop computer, a tablet computer, a mobile computing device (e.g., a cellular telephone), or any other similar device.

As shown in FIG. 2, the audio mixing device 101 may include an interface 201 for receiving audio elements or cut units from one or more sources and distributing final mixes to one or more of the audio playback devices 103₁-103_{N}. For example, dialogue cut units may include (1) production sounds that are recorded on set of a movie or television show; (2) looped or automated dialog replacement (ADR) sounds that are recorded in a studio; and (3) wild lines that are recorded on set but after filming has concluded or has been temporarily halted. Music and effects cut units may include (1) ambience that reproduces/emulates the space the scene is operating within; (2) Foley sounds that are typically small scale sound effects that are recorded in a studio synchronously with an accompanying video/picture; (3) so-called hard sound effects usually drawn from sound libraries; and (4) music tracks. Each of these cut units may be received by the interface 201 for processing and mixing as will be described in greater detail below.

The interface 201 may be any digital or analog interface that facilitates the transfer of audio content to/from an external device using electrical, radio, and/or optical signals. The interface 201 may be a set of digital interfaces including a set of physical connectors located on an exposed surface of the audio mixing device 101. For example, the interface 201 may include a High-Definition Multimedia Interface (HDMI) interface, an optical digital interface (Toslink), a coaxial digital input, a Universal Serial Bus (USB) interface, or any other similar wired interface. In one embodiment, the audio mixing device 101 transfers audio signals through a wireless connection with an external system or device (e.g., an audio source or the audio playback devices 103₁-103_{N}). In this embodiment, the interface 201 may include a wireless adapter for communicating with an external device using wireless protocols. For example, the input 201 may be capable of communicating using one or more of Bluetooth, IEEE 802.3, the IEEE 802.11 suite of standards, cellular Global System for Mobile Communications (GSM), cellular Code Division Multiple Access (CDMA), or Long Term Evolution (LTE).

The audio mixing device 101 may also include a main system processor 203 and memory unit 205. The processor 203 and memory unit 205 are generically used here to refer to any suitable combination of programmable data processing components and data storage that conduct the operations needed to implement the various functions and operations of the audio mixing device 101. The processor 203 may be a special purpose processor such as an application-specific integrated circuit (ASIC), a general purpose microprocessor, a field-programmable gate array (FPGA), a digital signal controller, or a set of hardware logic structures (e.g., filters, arithmetic logic units, and dedicated state machines) while the memory unit 205 may refer to microelectronic, non-volatile random access memory. An operating system may be stored in the memory unit 205, along with application programs specific to the various functions of the audio mixing device 101, which are to be run or executed by the processor 203 to perform the various functions of the audio mixing device 101. For example, the audio mixing device 101 may include a mixing unit 207, which, in conjunction with other hardware elements of the audio mixing device 101, combines audio components to form premixes and a final mix for a piece of sound program content. As will be described in further detail below, the final mix may include separate music and effects and dialogue stems that may be transmitted/distributed to one or more of the audio playback devices 103₁-103_{N} via the interface 201 such that the audio playback devices 103₁-103_{N} may control the music and effects stem relative to the dialogue stem. This control may include the volume and/or the application of dynamic range compression (DRC) to one or more of the stems.

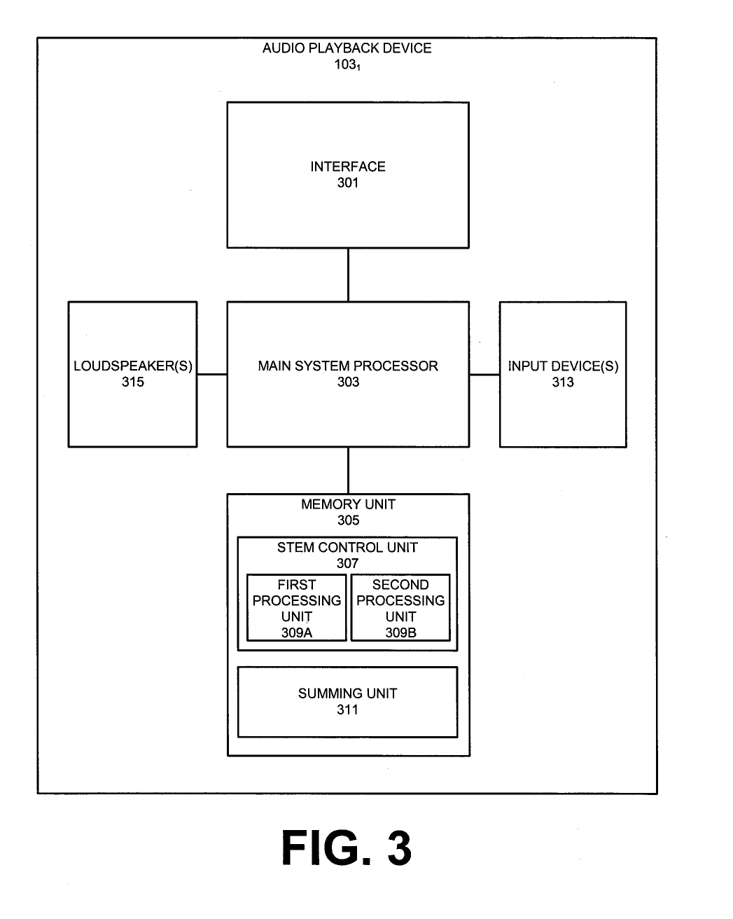

Turning now to FIG. 3, the audio playback device 103₁ will be described by way of example. Although the audio playback device 103₁is described and shown, it is understood that the audio playback devices 103₂-103_{N} may be similarly configured and designed.

As shown in FIG. 3, the audio playback device 103₁may include an interface 301 for receiving audio streams/stems, including a final mix that is comprised of multiple stems, from the audio mixing device 101. Similar to the interface 201, the interface 301 may be any digital or analog interface that facilitates the transfer of audio data to/from an external device using electrical, radio, and/or optical signals. The interface 301 may be a digital interface including physical connectors located on an exposed surface of the audio playback device 103₁. For example, the interface 301 may include a High-Definition Multimedia Interface (HDMI) interface, an optical digital interface (Toslink), a coaxial digital input, a Universal Serial Bus (USB) interface, or any other similar wired interface. In one embodiment, the audio playback device 103₁receives audio signals through a wireless connection with an external system or device (e.g., the audio mixing device 101). In this embodiment, the interface 301 may include a wireless adapter for communicating with an external device using wireless protocols. For example, the interface 301 may be capable of communicating using one or more of Bluetooth, IEEE 802.3, the IEEE 802.11 suite of standards, cellular Global System for Mobile Communications (GSM), cellular Code Division Multiple Access (CDMA), or Long Term Evolution (LTE).

As with the audio mixing device 101, the audio playback device 103₁ may include a main system processor 303 and memory unit 305. The processor 303 and memory unit 305 are generically used here to refer to any suitable combination of programmable data processing components and data storage that conduct the operations needed to implement the various functions and operations of the audio playback device 103₁. The processor 303 may be a special purpose processor such as an application-specific integrated circuit (ASIC), a general purpose microprocessor, a field-programmable gate array (FPGA), a digital signal controller, or a set of hardware logic structures (e.g., filters, arithmetic logic units, and dedicated state machines) while the memory unit 305 may refer to microelectronic, non-volatile random access memory. An operating system may be stored in the memory unit 305, along with application programs specific to the various functions of the audio playback device 103₁, which are to be run or executed by the processor 303 to perform the various functions of the audio playback device 103₁. For example, the audio playback device 103₁may include a stem control unit 307, which, in conjunction with other hardware elements of the audio playback device 103₁, controls properties of one or more stems within a final mix and received from the audio mixing unit 101. As noted above and as will be described in further detail below, the final mix may include separate music and effects and dialogue stems. The stem control unit 307 may control the music and effects stem relative to the dialogue stem to improve the intelligibility of the dialogue stem to a user of audio playback device 103₁. This control may include the volume and/or the application of dynamic range compression (DRC) to one or more of the stems. In one embodiment, the dialogue stem may be processed by the first processing unit 309A while the music and effects stem may be separately and simultaneously processed by the second processing unit 309B. The separately processed stems may thereafter be combined using the summing unit 311.

In one embodiment, the audio playback device 103₁may include one or more input devices 313. The input devices 313 may include a touch panel display, a mouse, a keyboard, a remote control, or any other similar device. In one embodiment, the input devices 313 may be used for controlling operation of the stem control unit 307. For example, a graphical user interface may be presented to a user of the audio playback device 103₁. The user interface may present a graphical slider or other graphical interface elements that allow the user to control the volume level of a music and effects stem relative to a dialogue stem for a piece of sound program content using one or more input devices 313. For example, a user may use a finger to slide a graphical slider downward to lower the volume of the music and effects stem while the dialogue stem remains fixed. The modified music and effects stem may be thereafter combined with the dialogue stem to generate a master mix that will be used to drive one or more loudspeakers 315.

As shown in FIG. 3, the audio playback device 103₁may include one or more loudspeakers 315. The loudspeakers 315 may emit sound into a listening area where one or more users/listeners are located. The listening area may be a location in which the audio playback device 103₁and/or the loudspeakers 315 are located and in which a user/listener is positioned to listen to sound emitted by the loudspeakers 315. For example, the listening area may be a room within a house or a commercial establishment or an outdoor area (e.g., an amphitheater).

The loudspeakers 315 may represent multiple audio channels for a piece of multichannel sound program content (e.g., an audio track for a movie). For example, each of the loudspeakers 315 may represent one of a front left channel, a front center channel, a front right channel, a left surround channel, a right surround channel, and a subwoofer channel for a piece of sound program content. Although six channel audio content is used as an example (e.g., 5.1 audio), the systems and methods described herein for optimizing sound reproduction may be similarly applied to any type of sound program content, including monophonic sound program content, stereophonic sound program content, eight channel sound program content (e.g., 7.1 audio), and eleven channel sound program content (e.g., 9.2 audio). In these embodiments, each of the channels may include a separate music and effects stem and dialogue stem. For example, a front right channel may include two audio stems (e.g., a music and effects stem and dialogue stem).

The loudspeakers 315 may be integrated into the audio playback device 103₁or they may be connected to the audio playback device 103₁ through a wired or wireless connection/interface. For example, the loudspeakers 315 may be connected to the audio playback device 103₁using wires or other types of electrical conduit. In this embodiment, each of the loudspeakers 315 may include two wiring points, and the audio playback device 103₁may include complementary wiring points. The wiring points may be binding posts or spring clips on the back of the loudspeakers 315 and the audio playback device 103₁, respectively. The wires are separately wrapped around or are otherwise coupled to respective wiring points to electrically connect the loudspeakers 315 to the audio playback device 103₁.

In other embodiments, the loudspeakers 315 may be coupled to the audio playback device 103₁using wireless protocols such that the loudspeakers 315 and the audio playback device 103₁are not physically joined but maintain a radio-frequency connection. For example, each of the loudspeakers 315 may include a Bluetooth and/or WiFi receiver for receiving audio signals from a corresponding Bluetooth and/or WiFi transmitter in the audio playback device 103₁. In some embodiments, the loudspeakers 315 may be standalone units that each include components for signal processing and for driving each transducer according to the techniques described below. For example, in some embodiments, the loudspeakers 315 may include integrated amplifiers for driving corresponding integrated transducers using wireless audio signals received from the audio playback device 103₁

As noted above, each of the loudspeakers 315 may include one or more transducers housed in a single cabinet. The transducers may be mid-range drivers, woofers, and/or tweeters. Each of the transducers may use a lightweight diaphragm, or cone, connected to a rigid basket, or frame, via a flexible suspension that constrains a coil of wire (e.g., a voice coil) to move axially through a cylindrical magnetic gap. When an electrical audio signal is applied to the voice coil, a magnetic field is created by the electric current in the voice coil, making it a variable electromagnet. The coil and the transducers' magnetic system interact, generating a mechanical force that causes the coil (and thus, the attached cone) to move back and forth, thereby reproducing sound under the control of the applied electrical audio signal coming from a source (e.g., a signal processor, a computer, and/or the audio playback device 103₁).

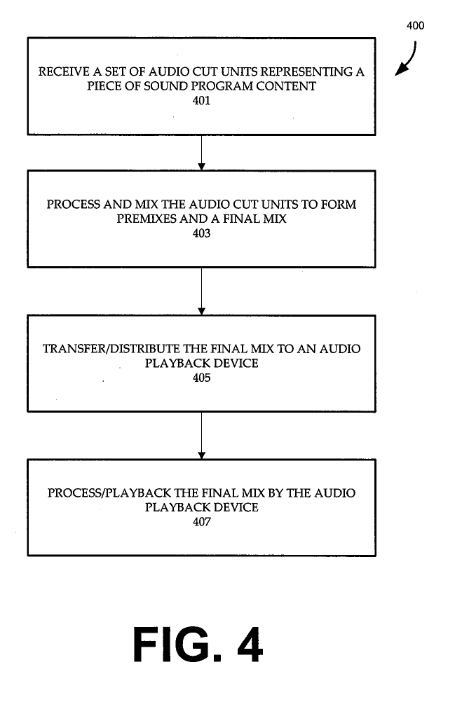

FIG. 4 shows a method 400 for mixing, distributing, and playing back a piece of sound program content comprised of multiple audio stems. As will be described in greater detail below, the method 400 allows the adjustment of various properties of the audio stems, including volume and DRC. Each operation of the method 400 may be performed by one or more of the audio mixing device 101 and the audio playback device 103₁. Although described in relation to the audio playback device 103₁, the method 400 may be simultaneously performed by one or more of the audio playback devices 103₂-103_{N} as well.

Further, although shown and described in a particular order, in other embodiments the operations of the method 400 may be performed in a different order. For example, in some embodiments, one or more of the operations of the method 400 may be performed in at least partially overlapping time periods.

The method 400 may commence at operation 401 with receipt of a set of audio cut units representing a piece of sound program content (e.g., a main audio track for a television show or a film). The audio cut units may be edited audio elements from a production that will collectively be used to form a final mix. In one embodiment, the audio cut units may be received at operation 401 by the interface 201 of the audio mixing device 101 from various production sources. The audio cut units may correspond to (1) music and effects or (2) dialogue components of the piece of sound program content. As noted above, dialogue cut units may include (1) production sounds that are recorded on set of a movie or television show; (2) looped or automated dialog replacement (ADR) sounds that are recorded in a studio; and (3) wild lines that are recorded on set but after filming has concluded or has been temporarily halted. Music and effects cut units may include (1) ambience that reproduces/emulates the space the scene is operating within; (2) Foley sounds that are typically small scale sound effects that are recorded in a studio synchronously with an accompanying video/picture; (3) so-called hard sound effects usually drawn from sound libraries; and (4) music tracks. Accordingly, the cut units represent the main sound elements for a movie or television show (e.g., a “Complete Main” mix) apart from complimentary soundtracks (e.g., director/actor or announcer commentary).

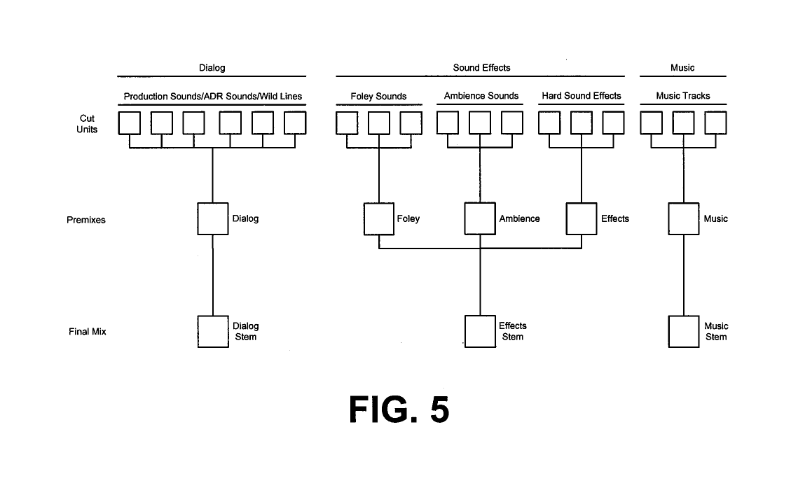

At operation 403, the audio cut units may be processed and mixed together to form a set of premixes and ultimately a final mix composed of a set of stems. FIG. 5 shows the construction of separate dialogue, music, and effects stems. As shown, numerous cut units may be combined to create a smaller set of premixes. The mixing of the cut units may include the adjustment of balances, spatialization, and reverb to ensure that each of the premixes sounds like a continuous track. In this example, dialog, Foley, ambience, sound effects, and music premixes may be generated out of respective sets of cut units; however, in other embodiments other sets of premixes may be generated, including additional types of sound effect premixes.

The premixes may be combined to produce a set of stems, which in-turn form the final mix. In some embodiments, the music stem may be directly created from sets of music cut units instead of from a set of intermediate premixes. The audio stems (e.g., the dialogue, music, and effects stems) may collectively represent a main soundtrack for a piece of content. For example, the dialogue, music, and effects stems may represent the main soundtrack for a television show or a movie. This main soundtrack represents sounds associated with a video stream of the television show or movie and is separate from complimentary sound elements, including commentary tracks.

In one embodiment, the music and effects stems may be combined at operation 403 such that the final mix includes two stems: (1) a dialogue stem and (2) a music and effects stem. The music and effects stems may be combined in a 1:1 manner as both stems represent the entirety of sounds for their respective components for the duration of the content and include the same number of channels. For the remainder of the discussion of the method 400, it will be assumed that the music and effects stems were combined into a single music and effects stem in the final mix at operation 403.

At operation 405 the final mix, including the dialogue stem and the combined music and effects stem, is transferred/distributed to the audio playback device 103₁. In one embodiment, the final mix may be transmitted from the audio mixing device 101 to the audio playback device 103₁via a network connection (e.g., the network 105). For example, a user of the audio playback device 103₁may browse a set of movies stored on the audio mixing device 101 or on a device associated with the audio mixing device 101. The movies may include a final mix that is comprised of separate dialogue and music and effects stems, which were generated as described above. A selected movie, including an associated final mix, may be transmitted via a network connection to the audio playback device 103₁at operation 405. The audio playback device 103₁may store the selected movie for later playback. In other embodiments, the final mix may be distributed through other mediums including DVD disc, Blu-ray disc, and other similar computer-readable mediums.

At operation 407, the audio playback device 103₁may begin to process and playback the final mix along with any associated video elements. For instance, in the example above in which a movie is downloaded that includes a video component and a final audio mix component, the video may be played-back through a corresponding video/picture monitor associated with or integrated within the audio playback device 103₁while each audio stem of the final audio mix (e.g., the dialogue stem and the music and effects stem) may be separately processed and played-back through the loudspeakers 315.

As noted above, playback of the final mix may include processing of each of the audio stems separately. For example, the dialogue stem may be processed by the first stem processing unit 309A of the stem control unit 307, while the second stem processing unit 309B of the stem control unit 307 may simultaneously process the music and effects stem. In particular, the second stem processing unit 309B may adjust the volume and/or the application of DRC to the music and effects stem based on various criteria and inputs while the dialogue stem may remain unmodified by the first stem processing unit 309A.

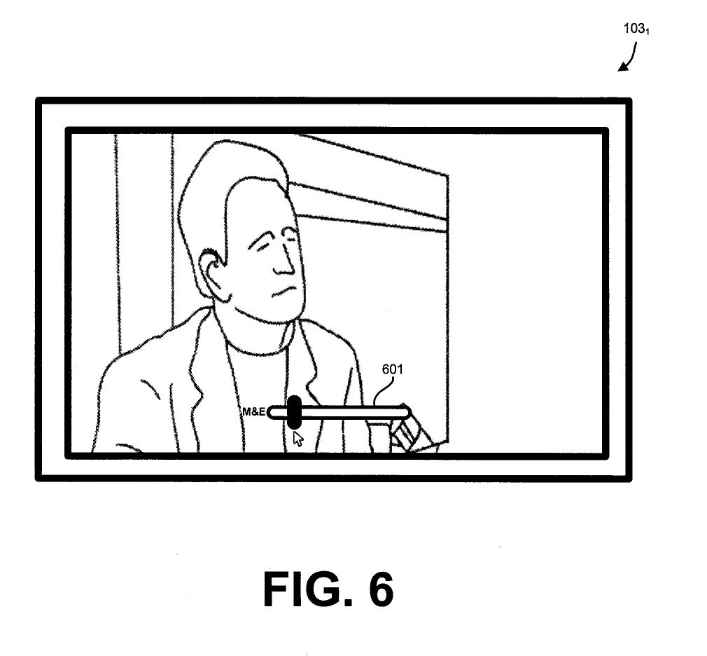

In one embodiment, the volume of the music and effects stem may be adjusted at operation 407 based on an input received from a user. For example, a graphical user interface element may be provided to a user on a monitor that simultaneously presents a video associated with the music and effects stem. The user may use one or more input devices to control the volume of the music and effects stem by adjusting the user interface element. For example, FIG. 6 shows a graphical user interface that may be presented to a user on a monitor of the audio playback device 103₁. The audio playback device 103₁may playback a piece of content, which includes a video stream and a final audio mix. The final audio mix may include a music and effects stem and a dialogue stem that represents sounds for the video stream. In the graphical user interface, the slider bar 601 may be used for adjusting the volume of the music and effects stem while both the video stream and final audio mix are being played by the audio playback device 103₁. As shown, a cursor controlled by a mouse, trackball, trackpad, remote control, touch screen, or another similar input device 313 may be used for moving the slider bar 601 and consequently changing the level of the music and effects stem relative to the dialogue stem. For example, sliding the bar 601 to the far right results in the reduction of the volume of the music and effects stem by 15 dB, sliding the bar 601 to the far left results in no reduction in volume of the music and effects stem (e.g., the music and effects stem is played at the same volume as originally set by the studio or production company), and sliding the bar 601 to some intermediate position between the far left and the far right results in a reduction in the volume of the music and effects stem by some value between 0 dB and 15 dB. Although 15 dB is used in the above example as the maximum amount of volume reduction for the music and effects stem, in other embodiments another maximum or threshold reduction level may be used. The maximum level of reduction may be selected such that the music and effects stem is not entirely removed from playback. In other embodiments, the volume level of the music and effects stem may be changed by other graphical user interface elements and/or input devices 313. For instance, a dedicated and/or mapped set of buttons on a hardware or virtual remote control may be used for adjusting the volume level of the music and effects channel while the dialogue stem remains unchanged in level.

In some embodiments, users/listeners may adjust the music and effects levels to improve intelligibility of the dialogue stem. In particular, the volume of the music and effects stem may be reduced/attenuated such that the dialogue stem may be more clearly heard. Traditionally, music and effects and dialogue stems were combined before transmission/distribution to the user/listener/consumer, most often in 1:1 level correspondence. Accordingly, adjustments to settings associated with the music and effects stem would also result in the adjustment of settings associated with the dialogue stem. While listening to a piece of sound program content, users would increase the volume during heavily dialogue focused portions and lower/attenuate the volume during heavily music/effects focused portions. This often resulted in the user continually adjusting the volume of the piece of sound program content. To achieve a harmonious balance between dialogue and music and effects, the method 400 allows independent adjustment of these corresponding stems by providing separate dialogue and music and effects stems to the audio playback device 103₁.

In some embodiments, the adjustment of volume of one of the stems may be automatically controlled by the stem control unit 307 at operation 407. For example, as the volume of the dialogue stem varies over time, the stem control unit 307 may maintain a predefined volume ratio between dialogue and music and effects stems. Namely, as the dialogue stem lowers in volume, the stem control unit 307 may cause the second processing unit 309B to also lower the music and effects stem in volume to maintain a predefined volume ratio. The predefined volume ratio may be preconfigured during design and manufacturing of the audio playback device 103₁or set by a user of the audio playback device 103₁.

In some embodiments, the attenuation of the music and effects stem relative to the dialogue stem may be limited to a maximum amount. For example, a predefined attenuation threshold may be 20 dB. In other embodiments, the attenuation may be limited to other threshold amounts, including between 12 dB and 15 dB. By limiting the amount that the music and effects stem may be attenuated, the method 400 ensures that at least some of the music and effects are perceived by users and are not entirely eliminated during playback.

In some embodiments, DRC may be selectively applied to the music and effects stem at operation 407. For example, the stem control unit 307 may determine the level of the dialogue stem. When the level of the dialogue stem is below a predefined DRC level for a sample period, the second processing unit 309B may apply downwards DRC to the music and effects stem. Application of downwards DRC may be performed in conjunction with automatic or user invocated adjustment of the volume of the music and effects stem. In these low level situations, DRC may improve the intelligibility of the dialogue stem by compressing the dynamic range of the music and effects stem while allowing the dialogue stem to remain unchanged. In some embodiments, the amount of DRC may be controlled by the detected sound level of the dialogue stem. For example, as the dialogue stem lowers in level, the amount of the DRC applied to the music and effects stem may increase.

Following adjustment of the music and effects stem, the adjusted music and effects and dialogue stems may be combined at operation 407. In one embodiment, the summing of the music and effects stem on the one hand, and the dialogue stem on the other hand, may be performed by the summing unit 311. Since the music and effects stem and the dialogue stem have the same number of channels (e.g., both stems are 5.1 signals), the summation may be 1:1.

Following summation, the combined music, effects, and dialogue signal may be used to drive corresponding loudspeakers 315 of the audio playback device 103₁. As described above, by adjusting properties of the music and effects stem independent of the dialogue stem, the method 400 may improve the intelligibility of the dialogue stem to one or more users/listeners. In particular, by attenuating the volume and/or controlling DRC applied to the music and effects stem, the method 400 may keep the relative volume of the dialogue stem high in comparison to the music and effects stem such that the dialogue stem is clearly intelligible to users. As explained above, the level of attenuating applied to the music and effects stem may be limited to ensure that music and effects are not entirely removed or removed beyond an acceptable level.

As explained above, an embodiment of the invention may be an article of manufacture in which a machine-readable medium (such as microelectronic memory) has stored thereon instructions that program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. The description is thus to be regarded as illustrative instead of limiting.

1. A method for playing back a piece of sound program content associated with a video stream to improve intelligibility of dialogue in the piece of sound program content, the method comprising:
receiving, by a playback device, a dialogue stem and a combined music and effects stem that represent the piece of sound program content;
controlling a level of the combined music and effects stem independent of the dialogue stem to produce a processed music and effects stem;
combining the processed music and effects stem with the dialogue stem to produce a master mix; and
playing back the master mix through a set of loudspeakers, earphones, or headphones associated with the playback device concurrently with the video stream.

2. The method of claim 1, wherein the level of the combined music and effects stem is controlled in response to a user input received using a graphical slider that is presented on a monitor that is concurrently displaying the video stream.

3. The method of claim 1, wherein controlling the level of the combined music and effects stem includes attenuating the combined music and effects stem independent of the dialogue stem such that the dialogue stem is played at a higher volume than the combined music and effects stem.

4. The method of claim 3, wherein the level of attenuation is controlled to be below a predefined attenuation threshold.

5. The method of claim 4, wherein the predefined attenuation threshold is 15 dB.

6. The method of claim 1, further comprising:
detecting that a level of the dialogue stem is below a predefined dynamic range compression (DRC) level during a sample period; and
in response to detecting that the level of the dialogue stem is below the predefined DRC level during the sample period, applying downwards DRC to the combined music and effects stem during the sample period.

7. The method of claim 6, wherein the application of DRC is controlled based on the detected level of the dialogue stem.

8. The method of claim 1, further comprising:
receiving, by a mixing unit, a set of cut units representing dialogue, music, and effects components for the piece of sound program content;
mixing the cut units to produce the dialogue stem, a music stem, and an effects stem; and
combining the music stem and the effects stem to produce the combined music and effects stem.

9. The method of claim 8, wherein the set of cut units represent one or more of: (1) production sounds that are recorded on set of a movie or television show; (2) looped or automated dialog replacement (ADR) sounds that are recorded in a studio; (3) wild lines that are recorded on set without a camera rolling; (4) ambience that emulates a space; (5) Foley sounds that are sound effects that are recorded in a studio; (6) hard sound effects recorded outside the Foley studio; or (7) music tracks.

10. An apparatus for playing back a piece of sound program content associated with a video stream to improve intelligibility of dialogue in the piece of sound program content, the apparatus comprising:
an interface for receiving a dialogue stem and a combined music and effects stem that represent the piece of sound program content;
a first processing unit for processing the dialogue stem;
a second processing unit for controlling a level of the combined music and effects stem independent of the dialogue stem to produce a processed music and effects stem;
a summing unit to combine the processed music and effects stem with the dialogue stem to produce a master mix; and
a set of transducers for generating sound for a user based on the master mix while the video stream is being concurrently played back.

11. The apparatus of claim 10, further comprising:
a monitor to concurrently display the video stream and a graphical slider, wherein the level of the combined music and effects stem is controlled in response to a user input received using the graphical slider.

12. The apparatus of claim 10, wherein controlling the level of the music and effects stem includes attenuating the combined music and effects stem independent of the dialogue stem such that the dialogue stem is played at a higher volume than the combined music and effects stem

13. The apparatus of claim 12, wherein the level of attenuation is controlled to be below a predefined attenuation threshold.

14. The apparatus of claim 13, wherein the predefined attenuation threshold is 15 dB.

15. The apparatus of claim 10, wherein the first processing unit detects a level of the dialogue stem is below a predefined dynamic range compression (DRC) level during a sample period and in response to detecting that the level of the dialogue stem is below the predefined DRC level during the sample period, the second processing unit applies DRC to the combined music and effects stem during the sample period.

16. The apparatus of claim 15, wherein the application of DRC is controlled based on the detected level of the dialogue stem.

17. The apparatus of claim 10, wherein the dialogue stem and the combined music and effects stem are composed of one or more of: (1) production sounds that are recorded on set of a movie or television show; (2) looped or automated dialog replacement (ADR) sounds that are recorded in a studio; (3) wild lines that are recorded on set without a camera rolling; (4) ambience that produces a spatial sensation; (5) Foley sounds that are sound effects that are recorded in a studio; (6) hard sound effects recorded outside the studio; or (7) music tracks.

18. The apparatus of claim 10, wherein the transducers are incorporated into one of a set of loudspeakers, earphones, or headphones.

19. A non-transitory computer readable medium, which stores instructions that when performed by a processor of a playback device cause the playback device to:
control a level of a combined music and effects stem independent of a dialogue stem to produce a processed music and effects stem;
combine the processed music and effects stem with the dialogue stem to produce a master mix; and
playback the master mix through a set of transducers associated with the playback device concurrently with a video stream.

20. The non-transitory computer readable medium of claim 19, wherein the level of the combined music and effects stem is controlled in response to a user input received using a graphical slider is that is presented on a monitor that is concurrently displaying the video stream.

21. The non-transitory computer readable medium of claim 19, wherein controlling the level of the combined music and effects stem includes attenuating the combined music and effects stem independent of the dialogue stem such that the dialogue stem is played at a higher volume than the combined music and effects stem.

22. The non-transitory computer readable medium of claim 19, further comprising instructions that when performed by a processor of a playback device cause the playback device to:
detect that a level of the dialogue stem is below a predefined dynamic range compression (DRC) level during a sample period; and
in response to detecting that the level of the dialogue stem is below the predefined DRC level during the sample period, apply downwards DRC to the combined music and effects stem during the sample period.

23. The non-transitory computer readable medium of claim 22, wherein the application of DRC is controlled based on the detected level of the dialogue stem.

24. The non-transitory computer readable medium of claim 19, wherein the level of the combined music and effects stem is controlled to maintain a predefined volume ratio between the dialogue stem and the processed music and effects stem.

25. The method of claim 1, wherein the level of the combined music and effects stem is controlled to maintain a predefined volume ratio between the dialogue stem and the processed music and effects stem.

26. The apparatus of claim 10, wherein controlling the level of the music and effects stem maintains a predefined volume ratio between the dialogue stem and the processed music and effects stem.
